(19) United States
(12) Patent Application Publication
(10) Pub. No.: US 2021/0040417 A1
(43) Pub. Date: Feb. 11, 2021

(54) DETERGENT SOLID COMPOSITION COMPRISING AMINOPOLYCARBOXYLATE AND ORGANIC ACID

(71) Applicant: Conopco Inc., d/b/a UNILEVER, Englewood Cliffs, NJ (US)

(72) Inventors: Hélène Julie Marie Arlabosse, Rotterdam (NL); Olaf Cornelis Petrus Beers, Vlaardingen (NL); Robert Jan Moll, Dordrecht (NL)

(73) Assignee: Conopco Inc., d/b/a UNILEVER, Englewood Cliffs, NJ (US)

(21) Appl. No.: 16/965,612

(22) PCT Filed: Feb. 12, 2019
(86) PCT No.: PCT/EP2019/053364

§ 371 Date: Jul. 29, 2020

(30) Foreign Application Priority Data
Feb. 23, 2018 (EP) 15158262.8
Feb. 23, 2018 (EP) 18158256.0
Feb. 23, 2018 (EP) 18158258.6
Feb. 23, 2018 (EP) 18158259.4
Feb. 23, 2018 (EP) 18158260.2
Feb. 23, 2018 (EP) 18158264.4
Feb. 23, 2018 (EP) 18158265.1
Feb. 23, 2018 (EP) 18158266.9
Feb. 23, 2018 (EP) 18158267.7
Feb. 23, 2018 (EP) 18158269.3
Feb. 25, 2018 (EP) 18158268.5

(51) Int. Cl. C11D 3/33; C11D 3/20; C11D 3/37; C11D 11/00; C11D 17/00

(52) U.S. Cl. CPC C11D 3/33; C11D 3/2082; C11D 3/2086; C11D 17/0095; C11D 11/0035; C11D 17/0091; C11D 3/3715

(57) ABSTRACT

A solid composition comprising: a) from 25 to 88 wt. % free acid equivalent of non-crystalline chiral aminopolycarboxylate; and b) from 10 to 60 wt. % free acid equivalent of non-crystalline organic acid different from aminopolycarboxylate; and c) from 2 to 30 wt. % of water wherein the pH of a solution made by dissolving the solid in water in a 1:1 weight ratio is at most 10.0, as measured at 25 degrees Celsius.

### FIELD OF THE INVENTION

The present invention relates to a solid composition comprising aminopolycarboxylate, and organic acid and water. The invention further relates to a process for the manufacture of the solid composition; and to a detergent product comprising the solid composition in an amount of from 1 to 90 wt. %.

### BACKGROUND OF THE INVENTION

Detergent products typically contain several different active components, including builders, surfactants, enzymes and bleaching agents. Surfactants are employed to remove stains and soil and to disperse the released components into the cleaning liquid. Enzymes help to remove stubborn stains of proteins, starch and lipids by hydrolyzing these components. Bleach is used to remove stains by oxidizing the components that make up these stains. In order to reduce the negative effects of in particular calcium and magnesium ions on stain/soil removal so called ‘builders’ (complexing agents) are commonly applied in detergent products.

Phosphorous based builders have been used for many years in a wide variety of detergent products. Some of the phosphorus based builders, such as trisodium phosphate and sodium tripolyphospate (STPP), have set a benchmark in the dishwasher detergent industry as having excellent performance. As such, phosphorus-containing builder components are generally considered to be “high-performance” builders. The use of phosphorous based builders in detergent products has led to environmental problems such as eutrophication. To curtail such problems many jurisdictions have, or are in the process of, issuing laws and regulations to restrict the maximum amount of phosphorous in detergent products. As such there has been a need for more environmentally friendly alternative builders, which have on-par effectiveness and which are also cost-effective. Examples of such alternative builders are aminopolycarboxylates, such as glutamic acid N,N-diacetic acid (GLDA), methylglycinediacetic acid (MGDA) and are ethylenediaminetetraacetic acid (EDTA). A drawback of many of such aminopolycarboxylates is that they tend to be hygroscopic.

WO 2014/086662 discloses a solid GLDA (i.e. a aminopolycarboxylate) material comprising a combination of GLDA, sulphuric acid and sodium sulfate crystals. Also described is a process of producing a solid GLDA composition comprising the consecutive steps of:
combining a GLDA sodium salt and sulfuric acid in a high-water activity phase; and
allowing water to evaporate from said phase to produce a precipitate.

It would be desirable to have available solid and stable aminopolycarboxylate solids that have attractive characteristics such as translucency or transparency. This would open-up new possibilities for designing detergent products comprising such solids with added visual appeal. Providing detergent products with added visual appeal is in fact of great importance for the commercial success of a detergent product. In the highly competitive detergent product market a detergent product needs to be visually attractive and at least be visually distinct from other such products.

It is an object of the present invention to provide a stable aminpolycarboxylate solid in a novel appealing form, which is suitable for use in detergent products, preferably further having improved dissolution/dispersion properties.

### SUMMARY OF THE INVENTION

One or more of the above objectives is achieved, in a first aspect of the invention, by a solid composition comprising:
a) from 25 to 88 wt. % free acid equivalent of non-crystalline chiral aminopolycarboxylate; and
b) from 10 to 60 wt. % free acid equivalent of non-crystalline organic acid different from aminopolycarboxylate; and
c) from 2 to 30 wt. % of water; and
   wherein the pH of a solution made by dissolving the solid composition in water in a 1:1 weight ratio is at most 10.0, as measured at 25 degrees Celsius.

The solid composition of the invention was found to be free of crystals of the chiral polycarboxylate and of the organic acid, as measured by WAXS using the method set-out in the Examples. Of course, as desired further ingredients can be mixed into the solid composition to provide a desired level of light transmittance (e.g. provide semi-translucency/semi-transparency). As such the solid composition of the invention has a tunable light transmittance, which is highly desirable in the making of detergent products. Surprisingly such a solid composition could be made using only known detergent actives. The composition also has low hygroscopicity, which improves (storage) stability.

Without wishing to be bound by theory it is believed that in the solid composition according to the invention, the organic acid is homogenously mixed with the chiral aminopolycarboxylate and molecularly interacts with it (although not being covalently bound to it). This is believed to prevent either of these components from (substantially) crystallizing. Thus it was found that it is possible to incorporate a significant amount of organic acid in the solid composition whilst retaining translucency. Another benefit of the inventive solid composition is that the composition can be free of further added crystal formation inhibitors.

The solid compositions according to the invention can surprisingly be made with the following process, which relates to the second aspect of the invention: Process for the manufacture of the solid composition according to the invention comprising the consecutive steps of:
I. providing an aqueous solution comprising:
   a) free acid equivalent of chiral aminopolycarboxylate; and
   b) free acid equivalent of organic acid different from a) wherein the weight ratio of a):b) is from 1:2 to 8.8:1; and
II. removing water from the aqueous solution by evaporation at a temperature of at least 50° C. to produce a liquid desiccated mixture having a water content of from 2 to 30 wt. %; and
III. reducing the temperature of the desiccated mixture to less than 25° C. to obtain a solid composition.

The desiccated liquid that is formed by reducing the water content of the solution to 30 wt. % or less is in a viscous (or rubbery) state. By cooling the desiccated liquid, the viscosity increases to a level where the material becomes solid. In case the desiccated liquid is cooled to a temperature lower than its glass transition temperature, a hard(er) solid can be obtained. This process offers the advantage that it allows for the production of the solid composition in the form of (shaped) pieces. Furthermore, the process can be used to coat a solid substrate with the solid composition by coating the substrate with the hot liquid desiccated mixture and allowing the hot mixture to cool down when in contact with the substrate. It was found that the solid composition of the present invention has thermoplastic behaviour which can suitably be used in the preparation of a detergent product and which also makes it more suitable for extrusion.

In view of the benefits provided by the solid composition of the invention, said solid composition can be used to make a detergent product having added visual appeal. For example it can be present as visually distinct part as such, or for example can be used as matrix. Importantly such detergent products with enhanced visual appeal can be made while only using detergent actives. Therefore, a third aspect of the invention relates to a detergent product comprising the solid composition according to the first aspect of the invention in an amount of from 1 to 90 wt. %.

A further aspect of the invention is the use of the solid composition according to the invention to provide a detergent product which in part or in whole is translucent.

It was also observed that the solid composition of the invention adds further to the visual appeal, apart from being translucent in being glossy in appearance. Hence a further aspect of the invention is the use of the solid composition according to the invention to provide a detergent product which is glossy in part or in whole.

### DETAILED DESCRIPTION

### Definitions

Weight percentage (wt. %) is based on the total weight of the solid composition or the detergent composition as indicated, unless otherwise stated. It will be appreciated that the total weight amount of ingredients will not exceed 100 wt. %. Whenever an amount or concentration of a component is quantified herein, unless indicated otherwise, the quantified amount or quantified concentration relates to said component per se, even though it may be common practice to add such a component in the form of a solution or of a blend with one or more other ingredients. It is furthermore to be understood that the verb “to comprise” and its conjugations is used in its non-limiting sense to mean that items following the word are included, but items not specifically mentioned are not excluded. Finally, reference to an element by the indefinite article “a” or “an” does not exclude the possibility that more than one of the elements is present, unless the context clearly requires that there be one and only one of the elements. The indefinite article “a” or “an” thus usually means “at least one”. Unless otherwise specified all measurements are taken at standard conditions. Whenever a parameter, such as a concentration or a ratio, is said to be less than a certain upper limit it should be understood that in the absence of a specified lower limit the lower limit for said parameter is 0.

The term ‘distinctive’ or ‘distinct’ as used herein in relation to the solid composition according to the invention means it is visually distinct/distinguishable by the untrained human eye.

The term ‘solid’ according to the invention is according to its commonplace usage. For example, a wineglass is considered a solid in common place usage although in a strict physical sense it is an extremely viscous liquid.

The term ‘aminopolycarboxylate’ includes its partial or full acids unless otherwise specified. The salts, rather than the acids, of the aminopolycarboxylates are more preferred, and particularly preferred are the alkali salts thereof. The term ‘organic acid’ includes partial or full alkali salts thereof unless otherwise specified.

Concentrations expressed in wt. % of ‘free acid equivalent’ refer to the concentration of an aminopolycarboxylate or an acid expressed as wt. %, assuming that the aminopolycarboxylate of acid is exclusively present in fully protonated from. The following table shows how the free acid equivalent concentrations can be calculated for some (anhydrous) aminopolycarboxylates and (anhydrous) acid salts.

| | Wt. % | Conversion | Wt. % free acid |
|---|---|---|---|
| | salt | factor | equivalent |
| GLDA (tetrasodium salt) | 50 | 263.1/351.1 | 37.5 |
| MGDA (trisodium salt) | 50 | 205.1/271.1 | 37.8 |
| Citric acid (monosodium | 50 | 192.1/214.1 | 44.9 |
| salt) | | | |
| Sodium acetate | 50 | 60.0/82.0 | 36.6 |

The term ‘translucency’ is used as meaning the ability of light in the visible spectrum to pass through the solid composition at least in part. To quantify, preferably it is evaluated based on a path-length of 0.5 cm through the solid composition, measuring the amount of light passing through. The solid composition is deemed to be translucent if under the aforementioned measurement conditions within the wavelength range of 400 to 700 nm it has a maximum Transmittance of at least 5%. The solid composition is deemed to be transparent if within the aforementioned wavelength range it has a maximum Transmittance of at least 20%. Here the Transmittance is defined as the ratio between the light intensity measured after the light has passed through the sample of solid composition and the light intensity measured when the sample has been removed.

Gloss is the fraction of light that is reflected in a specular (mirror-like) direction. The angle of the incident light at which gloss is measured is 20 degrees to obtain a measurement for ‘high gloss finish’, 60 degrees for ‘mid gloss finish’ and 85 degrees for ‘matt finish’. Good gloss attributes provides better visual appeal and cue's glass cleaning performance of the solid composition. These gloss values are measured using a Rhopoint IQ (Goniophotometer; Supplier Rhopoint Instruments) according to supplier instructions. To measure glossiness of the solid composition, this is done on an (isolated, continuous) sample of the solid composition, having a thickness of 0.5 cm, a flat smooth surface (e.g. shaped like a disk or plate) and using white paper as background (100% recycled paper, bright white; Supplier: Office Depot).

Advantageously, the solid composition has the following gloss properties to provide even better visual appeal:
A specular reflectance at 20 degrees of incident light of at least 5%, 10%, 15%, 20%, 25%, 30%, 35%, 40%, 45%, 50%, 55% and even more preferably at least 60%. Preferably the reflectance at 20 degrees of at most 95%, 90%, 85%, 80% and more preferably at most 75%. The most advantageous reflectance at 20 degrees being from 40 to 85%, more preferably from 50 to 80% and even more preferably from 55 to 75%.
A specular reflectance at 60 degrees of incident light of at least 5%, 10%, 15%, 20%, 25%, 30%, 35%, 40%, 45%, 50%, 55%, 60%, 65%, 70%, 75%, 80%, 85%. Preferably the reflectance at 60 degrees of at most 99.5%, 99.0%, 98.5% and more preferably 98.0%. The most advantageous reflectance at 60 degrees being from 50 to 99.5%, more preferably from 70 to 99.0% and even more preferably from 80 to 98.5%.
A specular reflectance at 85 degrees of incident light of at least 5%, 10%, 15%, 20%, 25%, 30%, 35%, 40%, 45%, 50%, 55% and even more preferably at least 60%. Preferably the reflectance at 85 degrees of at most 95%, 90%, 85%, 80% and more preferably at most 75%. The most advantageous reflectance at 85 degrees being from 40 to 85%, more preferably from 50 to 80% and even more preferably from 55 to 75%.
   Of course even more advantageously the solid composition has the preferred reflectance at 20, 60 and 85 degrees in combination (i.e. has a good high gloss finish and a good mid gloss finish and a good matt finish).

### Non-Crystalline Chiral Aminopolycarboxylate

Aminopolycarboxylates (chiral or non-chiral) are well known in the detergent industry and sometimes referred to as aminocarboxylate chelants. They are generally appreciated as being strong builders. Chirality is a geometric property of molecules induced by the molecules having at least one chiral centre. A chiral molecule is non-superimposable on its mirror image. The chiral aminopolycarboxylate as used in the invention can comprise all its molecular mirror images.

Chiral and preferred aminopolycarboxylates are glutamic acid N,N-diacetic acid (GLDA), methylglycinediacetic acid (MGDA), ethylenediaminedisuccinic acid (EDDS), iminodisuccinic acid (IDS), iminodimalic acid (IDM) or a mixture thereof, more preferred are GLDA, MGDA, EDDS or a mixture thereof and even more preferred are GLDA and MGDA or a mixture thereof. In case of GLDA preferably is it predominantly (i.e. for more than 80 molar %) present in one of its chiral forms.

Examples of non-chiral aminopolycarboxylates are ethylenediaminetetraacetic acid (EDTA), nitrilotriacetic acid (NTA), iminodiacetic acid (IDA), diethylenetriaminepentaacetic acid (DTPA), hydroxyethyliminodiacetic acid (HEIDA) aspartic acid diethoxysuccinic acid (AES) aspartic acid-N,N-diacetic acid (ASDA), hydroxyethylene-diaminetetraacetic acid (HEDTA), hydroxyethylethylene-diaminetriacetic acid (HEEDTA), iminodifumaric (IDF), iminoditartaric acid (IDT), iminodimaleic acid (IDMAL), ethylenediaminedifumaric acid (EDDF), ethylenediaminedimalic acid (EDDM), ethylenediamineditartaric acid (EDDT), ethylenediaminedimaleic acid and (EDDMAL), dipicolinic acid. None-chiral aminopolycarboxylates are preferably present in an amount of at most 10 wt. %, more preferably at most 5 wt. % and even more preferably essentially absent from the solid composition of the invention.

The solid composition of the invention comprises from 25 to 88 wt. % of free acid equivalent of chiral aminopolycarboxylates. A particularly preferred amount of chiral aminopolycarboxylate is from 30 to 70 wt. % and more preferably from 35 to 60 wt. %. The weight of the chiral aminopolycarboxylates is measured as based on the free acid equivalent.

Preferably, the solid composition of the invention contains at least 50 wt. %, more preferably at least 75 wt. % free acid equivalent of GLDA, MGDA, EDDS, IDS, IDM or a mixture thereof, based on the total weight of free acid equivalent of chiral aminopolycarboxylate. More preferably, the solid composition contains at least 50 wt. %, more preferably at least 75 wt. % free acid equivalent of GLDA, MGDA, EDDS or mixtures thereof, based on the total weight of free acid equivalent of chiral aminopolycarboxylate. Even more preferably the free acid equivalent of aminopolycarboxylate essentially consists of free acid equivalent of GLDA, MGDA, EDDS or a mixture thereof. GLDA in general is most appreciated as it can be made from bio-based materials (e.g. monosodium glutamate, which itself can be made as by-product from corn fermentation). Also GLDA is highly biodegradable.

### Non-Crystalline Organic Acid

The solid composition according to the invention comprises organic acid, said acid not being an aminopolycarboxylate. The organic acid used in the solid composition according to the invention can otherwise be any organic acid. Particularly good results were achieved with organic acids being polyacids (i.e. acids having more than one carboxylic acid group), and more particularly with di- or tricarboxylic organic acids.

Another preference is that the organic acids used in the invention have an average molecular mass of at most 500 Dalton, more preferably of at most 400 Dalton and most preferably of at most 300 Dalton, the molecular mass being based on the free acid equivalent. In any case, preferably the organic acid is not a polymer-based acid. The organic acid employed in accordance with the invention preferably comprises 3 to 25 carbon atoms, more preferably 4 to 15 carbon atoms.

In view of consumer acceptance the organic acids preferably are those which are also found naturally occurring, such as in plants. As such, organic acids of note are acetic acid, citric acid, aspartic acid, lactic acid, adipic acid, succinic acid, glutaric acid, malic acid, tartaric acid, maleic acid, fumaric acid, saccharic acids, their salts, or mixtures thereof. Of these, of particular interest are citric acid, aspartic acid, acetic acid, lactic acid, succinic acid, glutaric acid, adipic acid, gluconic acid, their salts, or mixtures thereof. Citric acid, lactic acid, acetic acid and aspartic acid are even more preferred. Citric acid and/or its salt are especially beneficial as, besides acting as builder are also highly biodegradable. As such it is advantageous that the solid composition contains at least 10 wt. %, more preferably at least 15 wt %, even more preferably at least 20 wt. %, most preferably at least 25 wt. % free acid equivalent of citric acid.

The solid composition of the invention comprises from 10 to 60 wt. % of the organic acid, the weight being based on the equivalent free acid. Preferred is a total amount of organic acid of from 15 to 55 wt. %, more preferably of from 25 to 50 wt. %, based on the weight of the free acid equivalents.

Better results were achieved with certain weight ratios of a):b). Therefore it is preferred that the weight ratio of a):b) is from 1:2 to 1:0.15, preferably from 1:1.5 to 1:0.4, more preferably from 1:1.4 to 1: 0.5, based on the weight of the free acid equivalents.

### Water

The solid composition according to the invention comprises from 2 to 30 wt. % of water. It was surprisingly found that use of such a water content provided a solid composition with a good balance of hardness and plasticity. Depending on the water level the solid composition can be a hard solid (water level of from 2 to 20 wt. %), or a soft solid (water level above 20 to 30 wt. %). The general plasticity and thermoplastic behaviour offers the significant practical advantage that the solid composition can be (machine) worked with a low chance of breakage or of forming cracks. Also, not unimportantly, it can provide an improved sensory experience when handled by the consumer. Better results were achieved with from 5 to 25 wt. % of water and better ones still with from 6 to 20 wt. % of water. The latter ranges provide a further optimum between suitable hardness, reduced brittleness and plasticity. The water-activity a_{w} of the solid composition according to the invention can be 0.7 or lower. Preferred is a water-activity a_{w} of at most 0.6, and further preferred of at most 0.5. The preferred lower limit of water activity a_{w} may be 0.15.

### pH Profile

The solid composition of the invention has the following pH profile: the pH of a solution of the solid composition made by dissolving the solid composition in water in a 1:1 weight ratio is at most 10.0, as measured at 25 degrees Celsius. Such a pH profile improves stability of the solid composition. Particularly good results were achieved for said pH profile being at most 9.0, more preferably at most 8.0. Many detergents products are overall alkaline. As such, for practical reasons and to increase formulation freedom, preferably the pH of a solution made by dissolving 1 wt. % of the solid composition in water is at least 5.0 and more preferably at least 6.0 and more preferably at least 6.5 as measured at 25 degrees Celsius.

### Further Ingredients

The solid composition of the invention may comprise further ingredients, such as further detergent active components.

Particularly good results were observed when polycarboxylate polymer was further comprised by the solid composition in an amount of from 1 to 50 wt. %, the weight being based on the free-acid equivalent. The term polycarboxylate polymer here is used to also cover the acid form. The polycarboxylate polymer is different from the organic acid used in this invention. The addition of polycarboxylate polymer was shown to surprisingly further improve the plasticity of the solid composition as well as raise the glass transition temperature (T_{g}) of the solid composition. The improved plasticity is beneficial as it makes the solid compositions easier to work and makes it easier to manufacture detergent product comprising the solid composition. A higher glass transition temperature is beneficial as it aids stability of the solid composition during storage and handling, in particular in view of temperature stresses. That being said a glass transition temperature which is not too high will aid quick dissolution of the solid composition in warm water as it helps to liquefy the solid composition during use by increasing surface area.

Preferably, the glass transition temperature (T_{g}) of the solid composition is less than 80 degrees Celsius, more preferably from 10 to 60 degrees Celsius, even more preferably from 15 to 50 degrees Celsius and most preferably from 20 to 40 degrees Celsius. Further improvements were observed when the solid composition comprised from 2 to 25 wt. % of polycarboxylate polymer, more preferably 3 to 15 wt. % of polycarboxylate polymer and even more preferably in an amount of from 1.8 to 8 wt. %, as based on the free-acid equivalent.

Suitable polycarboxylate polymers have an average molar mass Mw of from 500 to 500,000. They may be modified or unmodified, but preferably are unmodified. Also they can be co-polymers or homopolymers, although homopolymers are considered more beneficial.

Surprisingly, it was observed that solid compositions of the invention which comprised polycarboxylate polymer showed further reduced hygroscopicity. This reduction was more pronounced if the polycarboxylate polymer used were of lower molecular weight. Having a reduced hygroscopicity is of course beneficial as it aids in improving the (storage) stability of the solid compositions. Polycarboxylate polymers having an average molar mass (Mw) of from 900 to 100,000, more preferably 1100 to 10,000 gave better results in terms of further improving the glass transition temperature (T_{g}), plasticity and stability.

In a preferably, the solid composition comprises at least 0.3 wt. %, more preferably at least 0.6 wt. %, even more preferably at least 1 wt. % and most preferably at least 1.8 wt. % free acid equivalent of polycarboxylate polymer selected from polyacrylate, copolymers of polyacrylate, polymaleate, copolymers of polymaleate, polymethacrylate, copolymers of polymethacrylate, polymethyl-methacrylate, copolymers of polymethyl-methacrylate, polyaspartate, copolymers of polyaspartate, polylactate, copolymers of polylactate, polyitaconates, copolymers of polyitaconates and combinations thereof.

Highly preferred polycarboxylate polymers are polyacrylates. Suitable polyacrylates are commercially available, such as from BASF under the tradename Sokalan PA 13 PN, Solakan PA 15, Sokalan PA 20 PN, Sokalan PA 20, Sokalan PA 25 PN, Sokalan PA 30, Sokalan 30 CL, Sokalan PA 40, Sokalan PA 50, Sokalan PA 70 PN, Sokalan PA 80 S and Sokalan PA 110 S.

Preferred are polyacrylates which are partially or fully neutralized.

As such highly preferred for use in the solid composition of invention are polyacrylates having the following combined properties:
present in an amount of from 2 to 25 wt. %, based on the free acid equivalent; and
which are partially or fully neutralized; and
which have an average molar mass (Mw) of from 500 to 500,000; and
which are homopolymers.

Given the above it follows that still more preferred are polyacrylates having the following combined properties:
used in an amount of from 3 to 15 wt. %, based on the free acid equivalent; and
which are partially or fully neutralized; and
which have an average molar mass (Mw) of from 900 to 100,000; and
which are homopolymers.

The solid composition of the invention may, depending on the aminopolycarboxylate and acid used, be colored and for example have a yellowish tinge. The translucency of such first solid phase can be further improved by adding an opposing colorant of the color wheel, which is preferably a dye. For example, yellow opposes blue on the color wheel, and violet opposes green. This will render the first solid phase in essence to be more colorless, which can be preferred. It is noted that typical dyes need be added in relatively small amounts to be effective. Hence their level is suggested not to be above 0.5 wt. % and preferably is at most 0.2 wt. %.

Besides the optional presence of polyacrylates and colorants as indicated above, preferably the total amount of still further ingredients in the solid composition is at most 50 wt. %, more preferably at most 20 wt. %, still even more preferably at most 10 wt. %, still even more preferably at most 5 wt. %, still even more preferably at most 2 wt. % and still even more preferably essentially no further ingredients are present.

### Form of the Solid Composition

The solid composition of the invention can have any suitable shape and size. The solid composition may be in any form, but is preferably not a (fine) powder. The latter is since, when in a (fine) powder, the improved translucency of the solid composition will be difficult to appreciate due to the inherent light scattering properties of (fine) powders). As such, the weight geometric mean particle size is preferably at least 2 mm, more preferably at least 5 mm and even more preferably at least 1 cm.

When used, as part of a detergent product or otherwise, it is preferably present in at least one continuous volume of from 0.1 to 20 cm³, more preferably from 0.2 to 15 cm³, even more preferably from 0.4 to 10 cm³, most preferably from 0.5 to 5 cm³. Said preferred volumes allows the solid composition of the invention to be easily visible to the naked eye, allowing it to be better appreciated for its visual appeal. The solid composition may be present in any suitable shape.

The solid composition preferably has a maximum Transmittance within the wavelength range of 400 to 700 nm of at least 5%, more preferably of at least 10%, even more preferably of at least 20%, yet more preferably of at least 25% and most preferably of least 30%. According to another preference, the solid composition has an average Transmittance in the wavelength range of 400 to 700 nm of at least 5%, more preferably of at least 10%, even more preferably of at least 20% and most preferably of at least 25%.

### Detergent Product

According to the third aspect of the invention, the invention relates to a detergent product comprising the solid composition according to the first aspect of the invention. The detergent product comprises the solid composition according to the first aspect of the invention in an amount of from 1 to 90 wt. %, preferably in an amount of from 2 to 85 wt. %, more preferably of from 5 to 70 wt. %.

In case of machine dish wash detergent products, the particularly preferred amount of the solid composition of the invention is from 5 to 60 wt. %, more preferably 10 to 50 wt. % and even more preferably 15 to 40 wt. %.

In case of toilet bowl rim detergent products, the particularly preferred amount of the solid composition of the invention is from 10 to 85 wt. %, more preferably 20 to 80 wt. % and even more preferably 40 to 70 wt. %.

In case of laundry detergent products, the particularly preferred amount of the solid composition of the invention is from 1 to 60, more preferably 2 to 50 wt. %, and even more preferably, 5 to 35 wt. %.

Beneficially, at least part of the solid composition is visually distinct from the remainder of the detergent product part(s). The visual distinctiveness of the solid composition of the invention, is preferably based on the solid composition having (a higher) translucency compared to the other detergent product solid part(s). The distinctiveness of the solid composition can be further enhanced by a suitable distinctive colouring. This can be by making it of more intense or of less intense colour (e.g. colourless). Preferably of course when colouring is applied, the translucency is maintained to an appreciable extent. Generally colourants, such as dyes and/or pigments are effective in low amounts and as such this is typically not problematic. In any case, it is particularly envisioned that the solid composition of the invention is used in a detergent product and adds to the visual appeal thereof.

The solid composition can be present in the detergent product of the invention in any suitable shape or shapes, such as in one or more layers, lines (e.g. rods, beams), spherical or cuboid shapes or combinations thereof. Preferred shapes are the following: cuboid, cylinder, sphere, bar, X-bar, pyramid, prism, cone, dome and (circular) tube. Of these more preferred shapes are bar, X-bar, cylinder, cuboid, (circular) tube and sphere.

Whatever the geometric arrangement of the solid composition of the invention within the overall detergent product, it is preferred that at least part the solid composition forms part of the surface of the detergent product. More preferably, at least 10%, 20%, 30%, 40% more preferably at least 50% of the surface area of the detergent product is formed by the solid composition. Preferably at most 95%, 90% and more preferably at most 85% of the surface area of the detergent product is formed by the solid composition.

The solid composition of the invention in the detergent product may act as a matrix and hold part, or the whole, of the further ingredients in the detergent product. In this sense, the solid composition of the invention may be used to form a (partial) skin. Advantageously the solid composition acts as a translucent matrix holding one or more visually distinct bodies. The bodies being preferably in the shape of spheres or cubes. The bodies being preferably coloured.

In general, the skilled person is endowed with the capability to use the solid composition of the invention to his advantage when making more appealing detergent products. As described above, ways of using the solid composition in a detergent product in which the solid remains distinctly visible and can be appreciated for it translucent and/or glossy nature are highly preferred.

The detergent product according to the invention comprises the solid composition according to the invention. As such the detergent product (as a whole) will comprise chiral aminopolycarboxylate, organic acid and water by virtue of this. The detergent product in addition comprises, preferably in the other part(s), at least one further detergent active, and preferably one or more of enzymes, enzyme stabilizers, bleaching agents, bleach activator, bleach catalyst, bleach scavengers, drying aids, silicates, metal care agents, colorants, perfumes, lime soap dispersants, anti-foam, anti-tarnish, anti-corrosion agents, surfactants and further builders.

### Further Builders

Further builder materials may be selected from 1) calcium sequestrant materials, 2) precipitating materials, 3) calcium ion-exchange materials and 4) mixtures thereof. Examples of calcium sequestrant builder materials include alkali metal polyphosphates, such as sodium tripolyphosphate and organic sequestrants, such as ethylene diamine tetraacetic acid. Examples of precipitating builder materials include sodium orthophosphate and sodium carbonate. Preferably, the detergent product comprises sodium carbonate in the range from 5 to 50 wt %, most preferably 10 to 35 wt %. Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070. The detergent product may also contain 0-65% of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions. Zeolite and carbonate (carbonate (including bicarbonate and sesquicarbonate) are preferred further builders.

The builder may be crystalline aluminosilicate, preferably an alkali metal aluminosilicate, more preferably a sodium aluminosilicate. This is typically present at a level of less than 15 wt. %. Aluminosilicates are materials having the general formula: 0.8-1.5 M₂O. Al₂O₃. 0.8-6 SiO₂, where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alternatively, or additionally to the aluminosilicate builders, phosphate builders may be used. In this invention the term ‘phosphate’ embraces diphosphate, triphosphate, and phosphonate species. Other forms of builder include silicates, such as soluble silicates, metasilicates, layered silicates (e.g. SKS-6 from Hoechst). However, preferably the detergent product is a non-phosphate built detergent product, i.e., contains less than 1 wt % of phosphate and preferably essentially no phosphate.

In view of the environmental concerns associated with the use of high levels of phosphorous based builders in detergent compositions it is preferred that the detergent product according to the invention comprises at most 5 wt. %, more preferably at most 1 wt. % and particularly essentially no phosphorous based builders. Examples of phosphorous based builders are 1-hydroxyethane-1,1-diphosphonic acid (HEDP), diethylenetriamine-penta (methylenephosphonic acid) (DTPMP), ethylenediaminetetra-methylenephosphonate (EDTMP), tripolyphosphate, pyrophosphate.

Alkali carbonate is appreciated in view of its double-function as builder and buffer and is preferably present in the detergent product. If present the preferred amount of alkali carbonate in the detergent product is from 2 to 75 wt. %, more preferably from 3 to 50 wt. % and even more preferably from 5 to 20 wt. %. Such level of alkali carbonate provides good Ca²⁺ and Mg²⁺ ion scavenging for most types of water hardness levels, as well as other builder effects, such as providing good buffering capacity. The preferred alkali carbonates are sodium- and/or potassium carbonate of which sodium carbonate is particularly preferred. The alkali carbonate present in the detergent product of the invention can be present as such or as part of a more complex ingredient (e.g. sodium carbonate in sodium percarbonate).

### Surfactant

It is preferred that the detergent product of the invention comprises 0.5 to 70 wt. % of surfactant, more preferably 2 to 50 wt. %. The surfactant can be non-ionic or anionic.

In case of machine dish wash detergent products the particularly preferred amount of surfactant is from 0.5 to 25 wt. %, preferably 2 to 15 wt. %. In case of toilet bowl rim detergent products the particularly preferred amount of surfactant is from 0.5 to 55, preferably 10 to 40 wt. %. In case of laundry detergent products the particular preferred amount of surfactant is from 2 to 70, preferably 10 to 35 wt. %.

The nonionic and anionic surfactants of the surfactant system may be chosen from the surfactants described “Surface Active Agents” Vol. 1, by Schwartz & Perry, Interscience 1949, Vol. 2 by Schwartz, Perry & Berch, lnterscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

### Non-Ionic Surfactants

Suitable non-ionic surfactants which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide.

Preferably low-foaming nonionic surfactants are used particularly from the group of alkoxylated alcohols. Alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as are usually present in oxo alcohol residues, are preferably used as nonionic surfactants. In particular, however, alcohol ethoxylates with linear residues prepared from alcohols of natural origin with 12 to 18 C atoms, for example from coconut, palm, tallow fat or oleyl alcohol, and on average 2 to 8 mol of EO per mol of alcohol are preferred. The preferred ethoxylated alcohols include for example C₁₂₋₁₄ alcohols with 3 EO to 4 EO, C₉₋₁₂ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₉ alcohol with 5 EO. Preferred tallow fatty alcohols with more than 12 EO have from 60 to 100 EO, and more preferably from 70 to 90 EO. Particularly preferred tallow fatty alcohols with more than 12 EO are tallow fatty alcohols with 80 EO.

Nonionic surfactants from the group of alkoxylated alcohols, particularly preferably from the group of mixed alkoxylated alcohols and in particular from the group of EO-AO-EO nonionic surfactants, are likewise particularly preferentially used. Preferably used nonionic surfactants originate from the groups comprising alkoxylated nonionic surfactants, in particular ethoxylated primary alcohols and mixtures of these surfactants with structurally complex surfactants such as polyoxypropylene/polyoxyethylene/polyoxypropylene (PO/EO/PO). Such (PO/EO/PO) nonionic surfactants are furthermore distinguished by good foam control.

The most preferred nonionic surfactants are according to the formula:

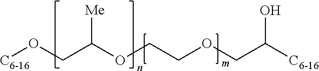

wherein n is from 0 to 5 and m from 10 to 50, more preferably wherein n is from 0 to 3 and m is from 15 to 40, and even more preferably wherein n is 0 and m is from 18 to 25. Surfactants according to this formula were particularly useful in reducing spotting of dishware treated in a machine dish washer. Preferably at least 50 wt. % of the nonionic surfactant comprised by the detergent product of the invention is nonionic surfactant according to this formula. Such nonionic surfactants are commercially available, e.g. under the tradename Dehypon WET (Supplier: BASF) and Genapol EC50 (Supplier Clariant).

The detergent product preferably comprises from 0.5 to 15 wt. % of nonionic surfactant. The more preferred total amount of nonionic surfactants is from 2.0 to 8 wt. % and even more preferred is an amount of from 2.5 to 5.0 wt. %. The nonionic surfactant used in the detergent product can be a single nonionic surfactant or a mixture of two or more non-ionic surfactants.

The nonionic surfactant is preferably present in amounts of 25 to 90 wt. % based on the total weight of the surfactant system. Anionic surfactants can be present for example in amounts in the range from 5 to 40 wt. % of the surfactant system.

### Anionic Surfactants

Suitable anionic surfactants which may be used are preferably water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic surfactants are sodium and potassium alkyl sulphates, especially those obtained by sulphating higher C8 to C18 alcohols, produced for example from tallow or coconut oil, sodium and potassium alkyl C9 to C20 benzene sulphonates, particularly sodium linear secondary alkyl C10 to C15 benzene sulphonates; and sodium alkyl glyceryl ether sulphates, especially those ethers of the higher alcohols derived from tallow or coconut oil and synthetic alcohols derived from petroleum. The preferred anionic surfactants are sodium C11 to C15 alkyl benzene sulphonates and sodium C12 to C18 alkyl sulphates. Also applicable are surfactants such as those described in EP-A-328 177 (Unilever), which show resistance to salting-out, the alkyl polyglycoside surfactants described in EP-A-070 074, and alkyl monoglycosides.

### Bleaching System

It is preferred that the detergent product according to the invention comprises at least 5 wt. %, more preferably at least 8 wt. % and even more preferably at least 10 wt. % of bleaching agent by total weight of the product. The bleaching agent preferably comprises a chlorine-, or bromine-releasing agent or a peroxygen compound. Preferably, the bleaching agent is selected from peroxides (including peroxide salts such as sodium percarbonate), organic peracids, salts of organic peracids and combinations thereof. More preferably, the bleaching agent is a peroxide. Most preferably, the bleaching agent is a percarbonate.

The detergent product of the invention may contain one or more bleach activators such as peroxyacid bleach precursors. Peroxyacid bleach precursors are well known in the art. As non-limiting examples can be named N,N,N′,N′-tetraacetyl ethylene diamine (TAED), sodium nonanoyloxybenzene sulphonate (SNOBS), sodium benzoyloxybenzene sulphonate (SBOBS) and the cationic peroxyacid precursor (SPCC) as described in U.S. Pat. No. 4,751,015.

Preferably the detergent product comprises a bleach catalyst. Particularly preferred is a bleach catalyst which is a manganese complex, such as Mn-Me TACN, as described in EP-A-0458397, and/or the sulphonimines of U.S. Pat. Nos. 5,041,232 and 5,047,163. It is advantageous that the bleach catalyst is physically separated in the detergent product from the bleach (to avoid premature bleach activation). Cobalt or iron catalysts can also be used.

### Enzymes

The detergent product of the invention preferably comprises one or more enzymes chosen from proteases, alpha-amylases, cellulases, lipases, peroxidases/oxidases, pectate lyases, and mannanases. Particularly preferred is protease, amylase or a combination thereof. If present the level of each enzyme is from 0.0001 to 1.0 wt. %, more preferably 0.001 to 0.8 wt. %.

### Silicates

Silicates are known detergent ingredients, and often included to provide dish wash care benefits, and reduce corrosion of dishware. Particularly preferred silicates are sodium disilicate, sodium metasilicate and crystalline phyllosilicates or mixtures thereof. If present the total amount of silicates preferably is from 1 to 15 wt. %, more preferably form 2 to 10 wt. % and even more preferably from 2.5 to 5.0 wt. % by weight of the detergent product.

### Perfume

Preferably the detergent product of the invention comprises one or more colorants, perfumes or a mixture thereof in an amount of from 0.0001 to 8 wt. %, more preferably from 0.001 to 4 wt. % and even more preferably from 0.001 to 1.5 wt. %.

Perfume is preferably present in the range from 0.1 to 1 wt. %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co. In perfume mixtures preferably 15 to 25 wt. % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

### Shading Dyes

In particular for laundry detergent products according to the invention it is preferred that these comprise shading dye. Shading dyes are for example added to laundry detergent formulations to enhance the whiteness of fabrics. Shading dyes are preferably blue or violet dyes which are substantive to fabric. A mixture of shading dyes may be used and indeed are preferred for treating mixed fiber textiles. The preferred amount of shading dyes is from 0.00001 to 1.0 wt. %, preferably 0.0001 to 0.1 wt. % and particularly an amount of 0.001 to 0.01 wt. % is preferred. Shading dyes are discussed in

WO2005/003274, WO2006/032327, WO2006/032397, WO2006/045275, WO2006/027086, WOO2008/017570, WO 2008/141880, WO2009/132870, WO2009/141173, WO 2010/099997, WO 2010/102861, WO2010/148624, WO2008/087497 and WO2011/011799.

### Form of the Detergent Product

The detergent product of the invention may be in any suitable form. Due to the presence of the solid composition of the invention it at least contains a solid part. The remainder of the detergent product can also be non-solid, such as in the form of a liquid, but preferably contains at least one further non-powder solid part.

The detergent product is preferably provided as a water-soluble or water-dispersible unit dose. Particularly preferred unit doses are in the form of pouches, which comprise at least one further non-shape stable ingredient, such as a liquid and/or powder; or in the form of tablets. For ease of use, the unit dose is sized and shaped as to fit in the detergent cup of a conventional house-hold machine dishwasher, laundry machine or toilet-rim holder, as is known in the art. In a preferred embodiment, the unit-dose detergent product has a unit weight of 5 to 50 grams, more preferably a unit weight of 10 to 30 grams, even more preferably a unit weight of 12 to 25 grams.

Advantageous unit dose pouches preferably have more than one compartment.

Advantageous unit dose tablets are those which have more than one visually distinct tablet region. Such regions can be formed by e.g. two distinct (colored) layers or a tablet having a main body and a distinct insert, such as forming a nested-egg. However oriented, one benefit of using multi-compartmental pouches/multi-region tablets is that it can be used to reduce/prevent undesired chemical reactions between two or more ingredients during storage by physical segregation.

Especially in case the detergent product is a machine dish wash detergent product, the more preferred unit dose is a tablet.

Preferably the unit dose detergent product is wrapped to improve hygiene and consumer safety. The wrapper advantageously is based on water-soluble film which preferably a polyvinylalcohol (PVA) based film. Such wrapping prevents direct contact of the detergent product with the skin of the consumer when placing the unit dose in the detergent cup/holder of a e.g. machine dishwasher. A further benefit of course is that the consumer also does not need to remove a water-soluble wrapping before use.

The detergent products according to the invention can be made using known methods and equipment in the field of detergent product manufacturing. The detergent product according to the invention can be made by combining the solid composition of the invention together with the remainder of the detergent ingredients. In view of making tablets, a particularly preferred way of combining is by pressing the solid composition onto (or into) the remainder of the tablet ingredients and/or by adding the solid composition in heated (liquid) form.

### Preferred Detergent Product Formulations

A highly preferred general detergent product formulation is as follows:

| Ingredient | Amount (wt. %) |
|---|---|
| Solid composition according to the invention | 1 to 80 |
| Surfactant | 0.5 to 70 |
| Phosphate | at most 1.0 |
| Preferably perfume and colorants | 0.0001 to 8.0 |
| in a combined amount of | |

In case of a machine dish wash detergent product the product is preferably a unit-dose tablet with the following composition:

| Ingredient | Amount (wt. %) |
|---|---|
| Solid composition according to the invention | 15 to 40 |
| Further builder, preferably alkali | 5 to 20 |
| carbonate | |
| Non-ionic surfactant | 0.5 to 15 |
| Enzyme | 0.001 to 0.8 |
| Silicates | 1 to 10 |
| Bleaching agent + bleach activator + | 2 to 20 |
| bleach catalyst | |
| Phosphate | at most 1.0 |
| Preferably perfume and colorants in a | 0.001 to 1.5 |
| combined amount of | |

In case of a toilet rim detergent product the product is preferably is a solid block composition, e.g. without comprising liquid parts and/or powder/granular parts and even more preferably having the following composition:

| Ingredient | Amount (wt. %) |
|---|---|
| Solid composition according to the invention | 40 to 70 |
| Anionic surfactant | 10 to 40 |
| Non-ionic surfactant | 0.5 to 15 |
| Bleaching agent + bleach activator | 2 to 20 |
| Total amount of phosphate | at most 1.0 |
| Preferably perfume and colorants in | 0.001 to 8 |
| a combined amount of | |

In case of a laundry detergent products these advantageously have the following composition:

| Ingredient | Amount (wt. %) |
|---|---|
| Solid composition according to the invention | 5 to 35 |
| Surfactant | 10 to 35 |
| Enzyme | 0.001 to 0.8 |
| Phosphate | at most 1.0 |
| Preferably perfume and colorants | 0.001 to 4 |
| in a combined amount of | |

### Process to Manufacture the Solid Composition

The process to manufacture the solid composition according of the invention, has the benefit of being both simple, economical and omits the need for adding further crystal formation inhibitors.

Step I. of the process according to the invention is to provide an aqueous solution comprising:
a) free acid equivalent of chiral aminopolycarboxylate; and
b) free acid equivalent of organic acid different from a);
   wherein the weight ratio of a):b) is from 1:2 to 8.8:1.

The combining of the ingredients at Step I. can be done in any order. The amount of water to be used in providing the aqueous solution beneficially is sufficient to fully dissolve the ingredients a) and b) at boiling temperature to simplify processing. Both the chiral aminopolycarboxylate and the organic acid may be added as a separate pre-made aqueous solutions, which is preferred to further simplify processing.

Heat may be applied to (more quickly) dissolve the ingredients a) and b). Applying heat at Step I. is preferred as it not only reduces the time to dissolve (if necessary) the ingredients a) and b), but it may also reduce the amount of water needed to provide the solution, saving costs. Also having less water in the solution provided at Step I. can save time for completing Step II. of the process. Preferably at Step I. an aqueous solution is provided having a temperature of at least 50, more preferably of at least 70, even more preferably of at least 90, and still even more preferably of at least 100 degrees Celsius.

The aqueous solution at Step I. should be homogenous at least in respects of the chiral aminopolycarboxylate, the organic acid and the water. As such it is particularly preferred that the aqueous solution of Step I. is subjected to physical mixing. The aqueous solution provided at Step I. may be viscous. Preferably the aqueous solution provided at Step I comprises from 40 to 95 wt. % of water, preferably from 45 to 85 wt. %.

The final solid composition is characterised by a pH profile of at most 10.0, based on a solution of the solid composition in water in a 1:1 weight ratio, as measured at 25 degrees Celsius. This can be easily achieved by suitably adjusting the pH of the aqueous solution accordingly, such as and preferably at Step I, using conventional means. For example, a balanced use of acid or (partially) neutralized salts forms of the ingredients a) and b) can be applied.

In Step II. of the process water is removed from the aqueous solution provided at Step I. by evaporation at a temperature of at least 50 degrees Celsius, to provide a water content of from 2 to 30 wt. %. Preferably, water is removed from the aqueous solution by evaporation at a temperature of at least 70 degrees Celsius, more preferably at least 90 degrees Celsius and most preferably at least 100 degrees Celsius.

The preferred way of removing water at Step II. is by applying sufficient heat to bring the aqueous solution provided at Step I. to a boil. This allows fast water removal which is advantageous to obtain the benefits of the solid composition according to the invention. As such the water removal may be done by any suitable means but preferably is such that the water removal is on-par with boiling at otherwise standard ambient conditions, or faster.

It is preferred that Step II. does not involve spray-drying. In particular spray-drying is considered to promote crystal formation and thus to reduce the translucency of the resulting solid composition.

In Step III. the temperature is of the desiccated mixture is reduced to less than 25° C. to obtain a solid composition. Preferably the temperature is reduced to from 20 to 25 degrees Celsius. Step III. can be performed use passive or active cooling. Active cooling may be done using any conventional means such as by refrigeration.

In a particularly preferred Step III., the cooling of the desiccated mixture is achieved by heat exchange with the remainder of the (cooler) detergent product parts. In this sense, it is particularly preferred that the ‘solid composition’ is applied in liquid/viscous form having an elevated temperature, onto the remainder of the detergent product and allowed to solidify in situ.

Preferably the solid composition according to the invention is obtainable by the process according to the invention. Solid compositions made according to the process of the invention were shown to be highly beneficial in view of the previously indicated attributes.

Unless otherwise indicated, preferred aspects in the context of the one aspect of the invention (e.g. the solid composition) are also applicable as preferred aspects in the context of one of the other aspects of the invention mutatis mutandis.

The invention is now illustrated by the following non-limiting examples.

### EXAMPLES

### Analytical Methods

### X-Ray Diffraction (XRD)

XRD was used to detect presence of crystalline material in the solid composition using to the Wide-Angle X-ray Scattering technique (WAXS). XRD was carried out using a D8 Discover X-Ray Diffractometer from Bruker AXS (activa number: 114175). The XRD measurements was performed using the following settings:

| | 2θ (7-55°) |
|---|---|
| Theta 1 | 7.000 |
| Theta 2 | 10.000/25.000/40.000 |
| X-ray generator (kV/μA) | 50/1000 |
| Time (sec) | 300 |
| Collimator (mm) | 1 |
| Detector distance (cm) | 32.5 |
| Tube Anode | Cu |

### Differential Scanning Calorimetry

Differential Scanning Calorimetry (DSC) was used to measure the glass transition temperature (Tg) of the solid composition. The equipment used of the DSC analysis was a Perkin Elmer power compensated DSC8000 equipped with an Intracooler III as cooling means. The stainless-steel sample pan was used which is provided with the equipment by the Supplier and filled according to Supplier instructions with material to be analyzed. The amount of material added to the sample pan (sample weight) was from 10 to 40 mg. The following settings were used in running the measurement:

| | |
|---|---|
| DSC | Hold for 1.0 min at 20.00° C.; |
| temperature | Cool from 20.00° C. to −20.00° C. at 10.00° C./min; |
| regime | Hold for 2.0 min at −20.00° C.; |
| | Heat from −20.00° C. to 90.00° C. at 5.00° C./min; |
| | Hold for 2.0 min at 90.00° C.; |
| | Cool from 90.00° C. to −20.00° C. at 10.00° C./min; |
| | Hold for 2.0 min at −20.00° C.; |
| | Heat from −20.00° C. to 90.00° C. at 5.00° C./min; |
| Atmosphere | Nitrogen 20 ml/min |

The Tg of the samples was measured with the second heating (i.e. the last heating step in the DSC temperature regime).

### Examples 1-8

Solid compositions according to the invention were made starting from an aqueous solution having a composition as set out in the following Table A.

TABLE A
Composition of aqueous solutions, amounts
are given in parts by weight.

| | Ex 1 | Ex 2 | Ex 3 | Ex 4 | Ex 5 | Ex 6 | Ex 7 | Ex 8 |
|---|---|---|---|---|---|---|---|---|
| ¹GLDA | — | — | — | — | — | 68 | 46 | 50 |
| ²MGDA | 50 | 60 | 70 | — | 60 | — | — | — |
| ³EDDS | — | — | — | 50 | — | — | — | — |
| ⁴Citric acid | 50 | 40 | 30 | 50 | — | 28 | 46 | 50 |
| ⁵Acetic acid | — | — | — | — | 40 | | — | — |
| ⁶Polyacrylate | — | — | — | — | — | 4 | 8 | — |
| ⁷Other | 6 | 7 | 9 | — | 7 | 4 | 3 | 3 |
| Water | 119 | 123 | 126 | 143 | 123 | 113 | 128 | 103 |

¹GLDA: Dissolvine GL-47-S (Supplier: Akzo Nobel) is a 47% solution of GLDA containing 50% water. The amount given in Table A is the amount of GLDA.
²MGDA: Trilon (M): (Supplier: BASF) is a 40% solution of MGDA containing 55% water. The amount given in Table A is the amount of MGDA.
³EDDS: (analytical grade, Supplier: Sigma Aldrich) is a 35% solution of the trinatrium salt of EDDS containing about 65% water. The amount given in Table A is the amount of EDDS.
⁴Citric Acid: used as a 50% solution. The amount given in Table A is the amount citric acid.
⁵Acetic Acid: used as a 50% solution. The amount given in Table A is the amount of acetic acid.
⁶Polyacrylate: Sokalan PA 25 CL (Supplier BASF), supplied as granules comprising 80% polyacrylate. Average molar mass Mw is 4000. The amount in Table A is the amount of polyacrylate.
⁷Contained in aminopolycarboxylate.

The aqueous solutions were heated to boiling in a frying pan. Next, boiling was continued to allow evaporation of water. The liquid was poured into a fully transparent petri dish and passively allowed to cool to room temperature at which a solid was formed.

The final water levels and the water activity (A_{w}) of the resulting solid compositions are given in the following table (Table B):

TABLE B

| | Water content | Water activity |
|---|---|---|
| | (wt. %) | (A_{w}) |
| Example 1 | 16.5 | 0.44 |
| Example 2 | 12.8 | 0.45 |
| Example 3 | 13.6 | 0.40 |
| Example 4 | 13.5 | 0.50 |
| Example 5 | 13.5 | 0.26 |
| Example 6 | 8.7 | 0.32 |
| Example 7 | 20.8 | n.d. |
| Example 8 | 14.2 | n.d. |

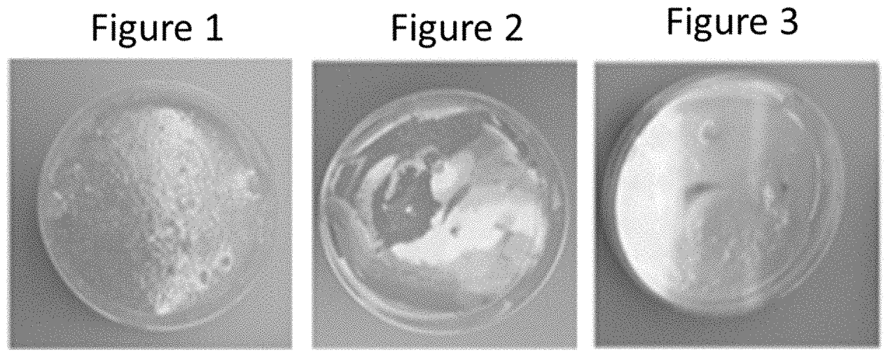

The solid compositions according to Examples 1 to 8 were subsequently analyzed. First, the translucency was evaluated by eye. All solid compositions according to the Examples were translucent (even transparent) and were glossy. FIGS. 1 to 3 are photographs taken from the solid composition of Example 1, 4 and 5 respectively.

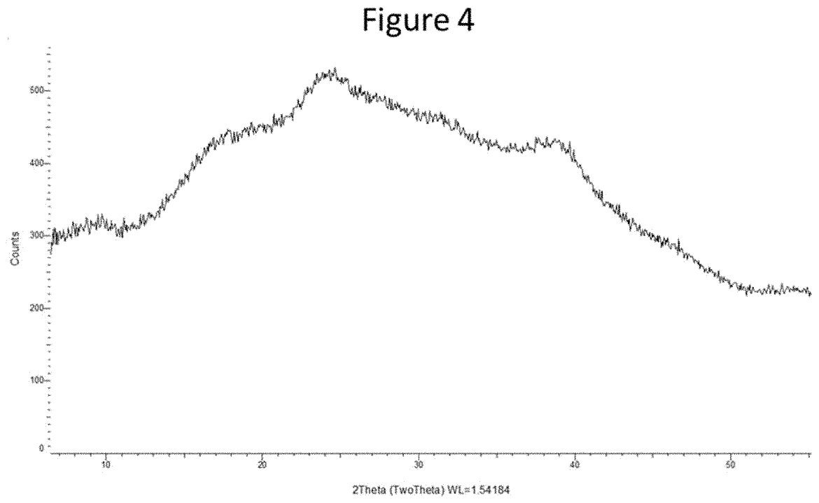

X-Ray Diffraction was used to assess the presence of crystals in the solid compositions. None of the solid compositions of the Examples showed detectable crystalline structures and were hence fully amorphous compositions. FIG. 4 is a WAXS graph of Example 1 (according to the invention) showing no detectable presence of crystals.

The solids of Example 6 and 7 showed substantially improved plasticity when compared to the solid of Example 8

The glass transition temperature (T_{g}) of the solid compositions was also analyzed. A relatively high T_{g} and given in the following table (Table C):

TABLE C
Glass transition temperature of the solid compositions.
Numbers for each solid composition represent the
averages of two independent measurements.

| | T_{g} (° C.) |
|---|---|
| Example 1 | 17 |
| Example 2 | 23.5 |
| Example 3 | 33 |
| Example 4 | 2.5 |
| Example 5 | 18 |

### Examples 9 and 10

Solid amorphous phases according to the invention were made starting from an aqueous solution having a formulation as set out in the following Table D.

TABLE D

| | Ex 9 | Ex 10 |
|---|---|---|
| ¹GLDA | 80 | 90 |
| ²Citric acid | 20 | 10 |
| ³Other | 5 | 6 |
| Water | 105 | 106 |

¹GLDA: Dissolvine GL-47-S (Supplier: Akzo Nobel) is a 47% solution of GLDA. The amount given in Table D is the amount of GLDA.
²Citric Acid: used as a 50% solution. The amount given in Table D is the amount citric acid.

The solid phases were prepared in the same was as described in Examples 1-8. Both solid phases were found to be translucent (even transparent) and glossy.

An aqueous solution of the solid composition was prepared (10 wt. % of the solid composition) and the pH of these solutions was determined at 25 degrees Celsius. The results are shown in Table E.

TABLE E

| | Ex 9 | Ex 10 |
|---|---|---|
| pH (10%) | 6.1 | 9.0 |

1. A solid composition comprising:
a) from 25 to 88 wt. % free acid equivalent of non-crystalline chiral aminopolycarboxylate; and
b) from 10 to 60 wt. % free acid equivalent of non-crystalline organic acid different from aminopolycarboxylate; and
c) from 2 to 30 wt. % of water
wherein the pH of a solution made by dissolving the solid in water in a 1:1 weight ratio is at most 10.0, as measured at 25 degrees Celsius,
wherein the organic acid has an average molecular mass of at most 500 Dalton, the molecular mass being based on the free acid equivalent.

2. A solid composition according to claim 1, wherein the weight ratio of a):b) is from 1:2 to 1:0.15, preferably from 1:1.5 to 1:0.4, more preferably from 1:1.4 to 1:0.5, based on the weight of the free acid equivalents.

3. A solid composition according to claim 1, wherein the amount of the chiral aminopolycarboxylate is from 30 to 70 wt. % and more preferably from 35 to 60 wt. %, the weight as based on the free acid equivalent.

4. A solid composition according to claim 1, wherein the amount of the organic acid is from 15 to 55 wt. %, preferably from 25 to 50 wt. %, the weight as based on the free acid equivalents.

5. A solid composition according to claim 1, wherein the chiral aminopolycarboxylate comprises GLDA, MGDA, EDDS or a mixture thereof and preferably wherein the chiral aminopolycarboxylate is GLDA, MGDA or a mixture thereof.

6. (canceled).

7. A solid composition according to claim 1, wherein the organic acid comprises acetic acid, citric acid, adipic acid, succinic acid, glutaric acid, malic acid, tartaric acid, maleic acid, fumaric acid, saccharic acid, their salt, or a mixture thereof, preferably wherein the organic acid comprises citric acid, lactic acid, acetic acid or mixtures thereof, and more preferably wherein the organic acid comprises citric acid.

8. A solid composition according to claim 1, wherein the organic acid is a dicarboxylic acid, tricarboxylic acid, dicarboxylate salt, tricarboxylate salt or a mixture thereof.

9. A solid composition according to claim 1, wherein the amount of water is from 5 to 25 wt. %, preferably from 10 to 20 wt. %.

10. A solid composition according to claim 1, wherein the pH of a solution made by dissolving the solid in water in a 1:1 weight ratio is at most 9.0, preferably at most 8.0, as measured at 25 degrees Celsius.

11. A solid composition according to claim 1, wherein the amount of the chiral aminopolycarboxylate is from 25 to 70 wt. % and wherein the solid composition further comprises from 1 to 50 wt. %, preferably 2 to 25 wt. % and more preferably 3 to 15 wt. % of free acid equivalent of polycarboxylate polymer.

12. A solid composition according to claim 1, wherein the solid composition has a maximum Transmittance within the wavelength range of 400 to 700 nm of at least 5%, preferably of at least 10%, more preferably of at least 20%, even more preferably of at least 25% and still even more preferably of least 30%, wherein the Transmittance is evaluated based on a path-length of 0.5 cm through the solid composition, measuring the amount of light passing through.

13. Process for the manufacture of the solid composition according to claim 1, comprising the consecutive steps of:
I. providing an aqueous solution comprising:
a) free acid equivalent of chiral aminopolycarboxylate; and
b) free acid equivalent of organic acid different from a) wherein the weight ratio of a):b) is from 1:2.4 to 8.8:1; and
II. removing water from the aqueous solution by evaporation at a temperature of at least 50° C. to produce a liquid desiccated mixture having a water content of from 2 to 30 wt. %; and
III. reducing the temperature of the desiccated mixture to less than 25° C. to obtain a solid composition.

14. A unit dose detergent product comprising the solid composition according to claim 1 in an amount of from 1 to 90 wt. %, preferably in an amount of from 2 to 85 wt. % and more preferably of from 5 to 70 wt. %, the unit dose detergent product preferably being a machine dish wash detergent product comprising 5 to 60 wt. % of surfactant.

15. Use of a translucent solid composition, having a composition according to claim 1 to provide a detergent product of which at least part thereof is translucent, and preferably transparent, wherein it is deemed translucent if it has a maximum Transmittance of at least 5% as evaluated based on a path-length of 0.5 cm, measuring the amount of light, within the wavelength of 400 to 700 nm, passing through; and wherein it is deemed transparent if it has a maximum Transmittance of at least 20% as evaluated based on a path-length of 0.5 cm through the solid composition, measuring the amount of light, within the wavelength of 400 to 700 nm, passing through.
